(19) United States
(12) Patent Application Publication
(10) Pub. No.: US 2023/0007993 A1
(43) Pub. Date: Jan. 12, 2023

(54) DEVICE FOR HANDLING SAMPLES AND METHOD OF OPERATING SUCH DEVICE

(71) Applicant: LIFE TECHNOLOGIES HOLDINGS PTE LTD, Singapore (SG)

(72) Inventor: JARI SAARELAINEN, VANTAA (FI)

(21) Appl. No.: 17/782,104

(22) PCT Filed: Dec. 2, 2020
(86) PCT No.: PCT/IB2020/061347

§ 371 Date: Jun. 2, 2022

(30) Foreign Application Priority Data
Dec. 3, 2019 (FI) 20196052

(51) Int. Cl. G01N 35/00

(52) U.S. Cl. CPC G01N 35/0098; G01N 35/00732; G01N 2035/0091

(57) ABSTRACT

The device for handling samples that are located in sample wells (2) of a sample vessel (1) and contain magnetic particles comprises a sample handling area (8) where the samples can be processed, a plurality of probes (3) that are insertable into the sample wells (2) for removing magnetic particles from the sample wells (2) or for inserting magnetic particles into the sample wells (2), and a display (13) which is located underneath the sample handling area (8).

### TECHNICAL FIELD OF THE INVENTION

The present invention relates to a device for handling samples that are located in sample wells of a sample vessel and contain magnetically responsive particles, as defined in the preamble claim 1. The invention also concerns a method of operating such a device in accordance with the other independent claim.

### BACKGROUND OF THE INVENTION

Magnetically responsive particles, herein also called magnetic particles, are employed in various methods, or assays, as a solid phase surface on which surface a reaction is allowed to occur. The magnetic particles typically comprise a core made of iron which is attractable by a magnetic field and are typically coated with a substance having a specific reaction with a given second substance in a liquid sample comprising a mixture of different substances. This allows separation of this given second substance from the assay mixture in which it is contained.

The reaction mixture is typically arranged in a sample well of a sample vessel. The particles usually need to be separated from the reaction mixture after the reaction. One way of separating the particles from the reaction mixture is removing the reaction medium from the sample well and leaving the particles in the sample well.

Alternatively, the particles can be removed from the well. This can be done with the aid of an elongated transfer probe comprising a magnet located within a shield and movable relative to the shield in the longitudinal direction of the shield. As the transfer probe is introduced into a mixture with the magnet in a lower position, the particles adhere to the surface of the transfer probe and can thus be removed from the mixture. By contrast, as the magnet is pulled into an upper position, the particles are detached from the surface of the transfer probe. A device for handling samples containing magnetic particles may comprise a plurality of transfer probes operating in parallel to allow simultaneous treatment of a plurality of samples. The magnets can have such a length that only the lower pole of the magnet collects particles. The magnets of the transfer probes can be oriented either in the same direction with each other, i.e. with similar poles always oriented in the same direction, or part of the magnets can be inversely oriented.

Devices for handling magnetic particles may be provided with a display which provides information on the status of the device. The display is typically on one side of an area where the vessel comprising the reaction mixture and the magnetic particles are located. The display located on a side of the device has a limited capability of reliably instructing a user of the device. Alternatively, the device may be operated via a computer comprising a dedicated operating software connected to the device.

Examples of commercially available devices are King Fisher™ magnetic particle processing instruments from Thermo Fisher Scientific.

### SUMMARY OF THE INVENTION

An object of the present invention is to provide an improved device for handling samples that are located in sample wells of a sample vessel and contain magnetically responsive particles. The device comprises a sample handling area where the samples can be processed, and a plurality of probes that are insertable into the sample wells for removing magnetically responsive particles from the sample wells or for inserting magnetically responsive particles into the sample wells. The characterizing features of the device according to the invention are given in the characterizing part of claim 1. Another object of the invention is to provide a method of operating such a device. The characterizing features of the method according to the invention are given in the other independent claim.

The device according to the invention comprises a display which is located underneath the sample handling area. Because of the display, various information can be shown to a user of the device in the area where the samples are processed. Because the user can simultaneously see both the display and the samples, the risk of making mistakes when using the device is reduced. Also, the use of the device is more effective, and the results of analysis performed on the samples are more reliable.

The method according to the invention comprises the steps of indicating on the display that the device is ready for a user action or for a selection or input by a user, waiting for the user action, selection or input, determining whether the correct action has been accomplished or asking for confirmation of the selection or input, and in case of a correct action or confirmed selection or input, proceeding to a following step of operation.

In the method according to the invention, the user is instructed on the display and the device determines whether the correct action has been performed or asks for confirmation of a selection or an input. The device thus interacts with the user, which reduces the risk of human errors, makes the process of using the device more effective and improves reliability of results of assays performed on samples.

According to an embodiment of the invention, the device is configured to show on the display information instructing a user of the device.

According to an embodiment of the invention, the device is configured to indicate on the display when a sample vessel can be loaded into the device or removed from the device.

According to an embodiment of the invention, the device is configured to indicate on the display that the sample vessel is/is not correct for a selected sample handling process.

According to an embodiment of the invention, the device is configured to instruct on the display how to load a sample vessel into the device.

According to an embodiment of the invention, the device is configured to identify on the display a sample vessel or sample wells requiring a specific action from a user of the device.

According to an embodiment of the invention, the device comprises a barcode or a QR-code reader or an RFID tag reader for reading information from a code or tag located in a sample vessel, and the device is configured to show on the display information based on the read code or tag.

According to an embodiment of the invention, the sample handling area comprises at least two predetermined sample handling locations, and the display is located underneath one of the predetermined sample handling locations.

According to an embodiment of the invention, the device comprises a rotatable platform for moving a sample vessel between the sample handling locations.

According to an embodiment of the invention, the display is located underneath a sample handling location which is configured to allow loading of a sample vessel into the device and/or removing a sample vessel from the device.

According to an embodiment of the invention, the display is configured to be visible to a user of the device while the sample vessel is being loaded into the device and/or removed from the device.

According to an embodiment of the invention, in the method a wrong action or a cancelled selection or input is indicated on the display.

### BRIEF DESCRIPTION OF THE DRAWINGS

Embodiments of the invention are described below in more detail with reference to the accompanying drawings, in which

FIG. 1 shows a device according to an embodiment of the invention,

FIG. 2 shows another view of the device of FIG. 1,

FIG. 3 shows a sample well and a probe for separating magnetic particles from a sample located in the sample well,

FIG. 4 shows another view of the probe of FIG. 3,

FIG. 5 shows an example of a sample vessel comprising a plurality of sample wells,

FIG. 6 shows as a block diagram parts of a device according to an embodiment of the invention,

FIG. 7 shows as a flowchart a method according to an embodiment of the invention, and

FIG. 8 shows as a flowchart a method according to another embodiment of the invention.

### DESCRIPTION OF EMBODIMENTS OF THE INVENTION

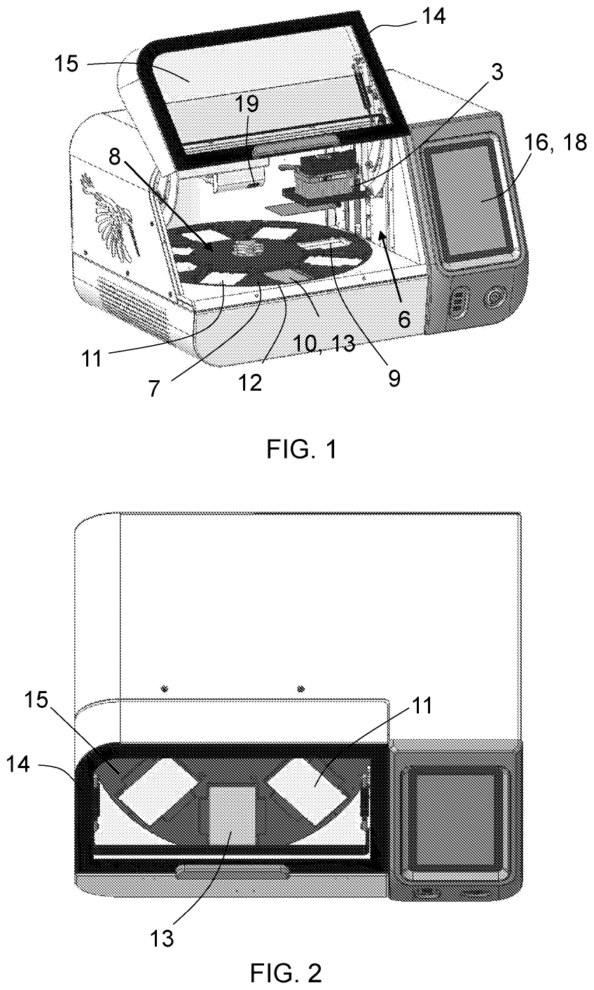

The invention concerns a device for handling samples containing magnetic particles. The magnetic particles are utilized in separating a substance from a liquid sample. The sample is typically a biological sample, and the substance to be separated may for example consist of cells (e.g. bacteria or cancer cells), proteins (e.g. antigens or antibodies), enzymes, or nucleic acids. A large variety of particles that are suitable for such purposes are commercially available. The particles are coated with an affinity reagent for the substance to be separated, or the surface intrinsically interacts with the substance. For example, a silica surface may interact with nucleic acids without specific coating. The size of the magnetic particles can be for example in the range of 0.5-10 μm, typically 1-5 μm. The volume of the sample from which the particles are collected and released into is typically in the range of 20-1000 μl, but the volume used in different assays could also be essentially larger or smaller. FIGS. 1 and 2 show a device according to an embodiment of the invention.

The samples are located in sample wells which are arranged in a sample vessel. Each sample well has an open upper end. The sample vessel can be for example a microplate 1 comprising an array of sample wells. An example of a microplate is shown in FIG. 5. A microplate is a flat plate comprising a plurality of wells, i.e. cavities that are arranged in rows and columns. The wells are configured to receive samples and function as small test tubes. A typical microplate comprises 6, 24, 96, 384 or 1536 wells, although also larger microplates exist. The wells are arranged in a rectangular matrix, where the ratio between the sides is typically 2:3. Microplates with different well depths are provided for different sample volumes needed. Instead of a microplate, the sample vessel could also be, for instance, a rack or a frame which is configured to hold separate sample wells or sample well modules comprising a plurality of sample wells. Different types and sizes of wells could thus be provided for different assay steps. The sample vessels could also be provided as strips comprising e.g. 4, 6, 8, 10 or 12 wells.

The device comprises a plurality of magnetic transfer probes for collecting the magnetic particles and for releasing the particles. The probes are configured to attract the particles and to allow releasing of the particles. Each probe produces a magnetic field which attracts magnetically responsive particles which can adhere to the probe. Each probe comprises a magnet rod for attracting the magnetic particles. The rod can be surrounded by a shield. One end of the probe can be inserted into a sample well. The shield is hollow and has a closed lower end and an open upper end. The magnet rod is moveable up and down at least partly inside the hollow shield through its upper end. When the particles are collected, the magnet is kept in a lower position inside the shield, whereby the particles gather and attach to the lower end of the shield. For releasing the particles, the magnet is lifted to an upper position, wherein the magnet no longer holds the particles attached on the shield and the particles can be released into the sample liquid. With the probe, the magnetic particles can be transferred from a sample well to another sample well or onto a collecting surface.

It is not necessary to provide the probes with shields. However, if a probe is not provided with a shield, the magnet rod should be purified after it has been used for an assay. Therefore, it is advantageous to use shields. The number of shields usually corresponds to the number of sample wells in a sample vessel, but it would also be possible to leave some wells of the vessel unused in which case a shield would not be needed.

Magnet rods, vessels and shields of different sizes and shapes are available to meet the needs of different assays.

The magnet can be a permanent magnet. The length of the magnet is preferably so much greater than the diameter of the magnet that the particles are gathered as a concentrated spot or ring on the tip of the shield. Most preferably, the magnet is so long that the upper pole of the magnet is kept above the surface of the liquid from which the particles are separated. When the particles are collected from a large liquid volume (e.g. up to 50 ml), it may be preferable to concentrate the particles first on the side wall or bottom of the sample well.

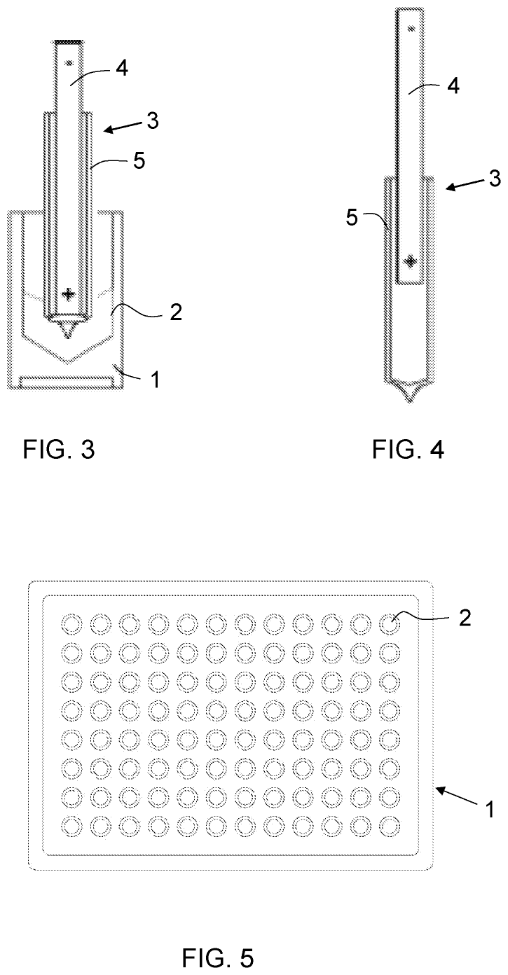

FIG. 3 shows an example of a probe 3 that has been inserted into a sample well 2 of a microplate 1. The sample well 2 contains a liquid sample from which a desired substance is to be separated. Therefore, magnetically responsive particles selectively interacting with the substance have been suspended with the sample. The particles interact with the substance, and the substance is thereby fixed on the surface of the particles. Thereafter a magnetic probe 3 is introduced into the sample well 2 in order to collect the particles. The probe 3 comprises an elongate permanent magnet 4 covered by a hollow shield 5. The magnet 4 is moveable up and down in the shield 5, and the particles are collected keeping the magnet in its lower position. The magnets 4 can be, for instance, neodymium magnets (NdFeB). The upper end of the magnet 4 extends well above the liquid surface in the sample well 2. The lower end of the shield 5 has tapering concave surface with a sharp tip so that the particles concentrate as a ring on the concave surface area of the tip. When collecting the particles, the probe 3 is moved a few times slowly up and down.

After the particles have been collected to the probe 3, the probe 3 is lifted out of the sample well 2 keeping the magnet 4 still in its lower position, whereby the particles keep reliably attached to the probe 3. In practice, the particles would keep attached to the probe 3 after it has been lifted from the sample well 2 even if the magnet 4 was lifted from the lower position. After removal from the sample well 2, the particles are usually washed in at least one step, and preferably in several steps. The washing is preferably carried out so that the end of the probe 3 is placed in a washing liquid and the magnet 4 is lifted, whereby the particles are released into the liquid. FIG. 4 shows the magnet 4 in an upper position. After washing, the particles are again collected by the probe 3. A small amount of liquid is adhered to the surfaces of the particles, i.e. the particles are wet. After washing, the particles can be released into another sample well by inserting the probe 3 into the sample well and lifting the magnet 4 to the position shown in FIG. 4.

Alternatively, the probe 3 could be contacted perpendicularly with a horizontal plate at a release location, below which a release magnet is arranged. By moving the magnet 4 of the probe 3 upwards, the magnetic particles would be released and attracted by the release magnet. The magnetic particles would form a concentrated spot on the release location.

The number of the probes 3 of the device preferably corresponds to the number of the sample wells 2 in the sample vessel 1. The device can be configured for use with microplates of a certain size, and the number of the probes 3 can thus correspond to the number of wells in the microplate. The probes 3 are arranged in a similar matrix as the wells of the microplate.

The shields 5 can be arranged in a shield module. The magnets can be arranged in a magnet module. Both the shield module and the magnet module can be detachable. Different modules can be provided for different sample vessels. For instance, different sample vessels may require a different number of probes and different shield/magnet dimensions and shapes. With detachable modules, the device can be easily adapted for use with different sample vessels.

The probes 3 are attached to a lifting device 6. The lifting device 6 is configured to move the probes 3 in the vertical direction, and the probes 3 can thus be inserted into the sample wells 2 via the open upper ends of the sample wells 2. The lifting device 6 is also configured to allow the magnets 4 to be moved in the vertical direction relative to the shields 5. The magnets 4 can thus be lifted while keeping the shields 5 inserted in the sample wells 2. This allows the magnetic particles to be released into the sample wells 2.

The device comprises a rotatable platform 7. The rotatable platform 7 covers a sample handling area 8, where samples located in sample wells can be processed. By means of the platform 7, sample vessels can be moved between predetermined sample handling locations. The device is configured to automatically rotate the platform 7 according to a predetermined procedure. One of the sample handling locations 9 is located below the lifting device 6. In the sample handling location 9 located below the lifting device 6, magnetic particles can be separated from samples or inserted into sample wells.

One of the sample handling locations is a loading location 10, where a sample vessel can be loaded into the device and removed from the device. The sample handling area 8 also comprises further sample handling locations 11 which can be dedicated for different purposes, such as for heating or cooling the samples or dispending of reagents. Some of the sample handling locations can be reserved for holding the sample vessels utilized in subsequent process steps. One or more of the sample handling locations 11 could thus be provided with heating elements for heating the samples in the sample wells, with cooling elements, or with dispensing means for dispensing of liquids into the sample wells 2. A sample handling location could also be provided with a magnet arranged below the platform 7.

The platform 7 comprises a plurality of retaining areas 12. Each retaining area is configured to hold a sample vessel. In the embodiment of FIGS. 1 and 2, the retaining areas 12 are implemented as apertures of the platform 7. Each aperture can receive a sample vessel, which is supported against the edges of the aperture. However, instead of the apertures, the retaining areas could comprise retaining elements for positioning and holding sample vessels.

The device comprises a barcode reader 19. The barcode reader 19 is located so that a barcode in a sample vessel 1 can be read when the sample vessel is loaded into the device at the loading location 10. The barcode reader 19 can also be used for reading barcodes of the shield modules and magnet modules. The reader could also be configured to read QR-codes or similar codes instead of or in addition to barcodes. The reader could also be configured to read RFID tags. The sample vessels and the shield modules and magnet modules could thus be provided with RFID tags.

At least one display 13 is located below the sample handling area 8. In the embodiment of FIGS. 1 and 2, the display 13 is located at the loading location 10. However, instead of the loading location 10 or in addition to that, also other sample handling locations 9, 11 could be provided with displays. The display 13 is viewable during the use of the device. The device comprises a door 14 which can be closed when the samples are being processed by the device. The door 14 comprises a window 15, through which the display 13 can be seen also during the processing of the samples. The display 13 is located so that it can be seen through the apertures 12 of the platform 7. If the retaining areas of the platform were implemented without apertures, at least part of the platform 7 could be made transparent for allowing the display 13 to be seen through the platform 7.

Various information can be shown on the display 13. The device can be configured to show on the display information instructing a user of the device. The information can be, for instance, in the form of color codes, text, images, animations or videos. For example, the device can be configured to indicate on the display 13 when a sample vessel can be loaded into the device. Alternatively, or in addition to that, the device can be configured to indicate on the display 13 when a sample vessel can be removed from the device. The instructions can be given, for instance, as color codes, text, images or animations.

The device can also be configured to indicate on the display 13 that the sample vessel is correct or is not correct for a selected sample handling process (assay). For instance, the sample vessels can comprise a barcode or a QR-code or an RFID tag, and the device can comprise a barcode or a QR-code reader 19 or an RFID reader. Based on the read code or tag, the device can determine whether the sample vessel can be used for the selected process. The result can be shown on the display 13, for instance as a color code, text or image. Also the probe modules and the magnet modules can be provided with barcodes, QR-codes or RFID tags which can be read by the reader. The device can be configured to determine whether the modules can be used in the selected process and also this information can be shown on the display 13.

The device could also instruct the user on how to load a sample vessel into the device. The device could also show on the display an image of a specific type of sample vessel that should be used for a certain process.

The device could also be configured to identify a sample well requiring a specific action from the user. For instance, the display 13 could show light below the sample wells requiring some action from the user.

The display 13 can be implemented using various technologies. For instance, the display 13 could be a liquid-crystal display (LCD), LED display or OLED display. Such displays would enable showing detailed images, text passages or for example animations or videos. However, in some cases it may sufficient to show different colors, individual words, simple icons or similar information. In such cases, the display could be for example a LED matrix. The LED matrix refers here to a group of LEDs, where the individual LEDs can be distinguished with naked eye.

The device comprises also another display 16. The other display 16 is arranged adjacent to the sample handling area 8. The display 16 functions as a main display of the device. The display 13 below the sample handling area functions as an auxiliary display. Because the auxiliary display 13 is located underneath the sample handling area 8, a user of the device can see simultaneously the samples and the display 13. This makes the use of the device more effective and reduces the risk of human errors.

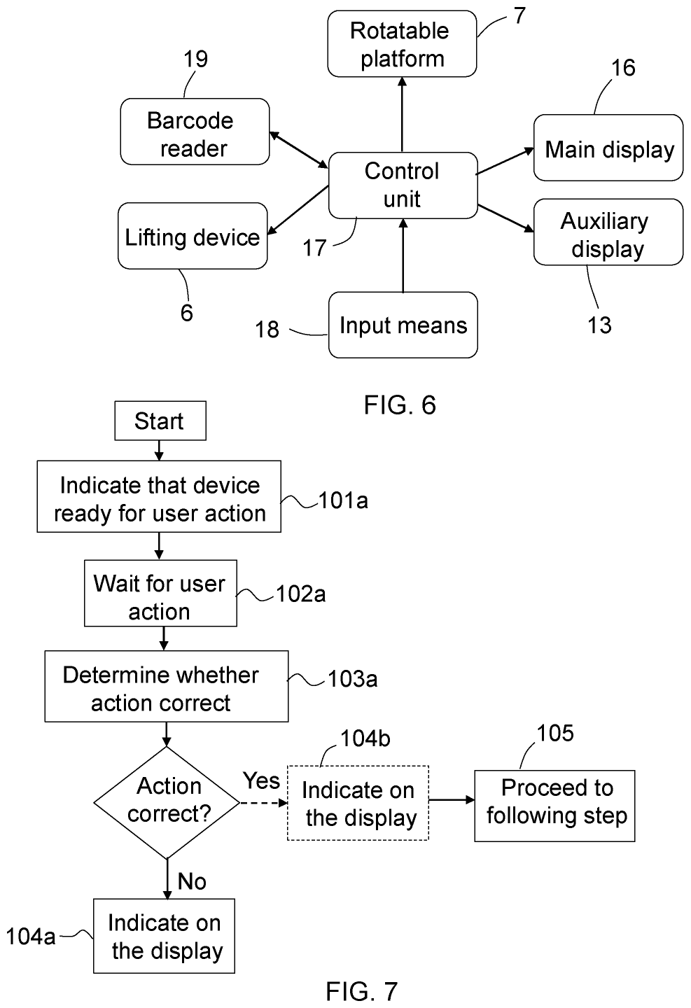

FIG. 6 shows a device according to an embodiment of the invention as a block diagram. The device comprises a control unit 17. The control unit 17 can comprise a central processing unit (CPU) and a memory. The control unit 17 can comprise both a volatile and a non-volatile memory, which communicate with the CPU. The control unit 17 controls the operation of the rotatable platform 7 and the lifting device 6. The control unit 17 can further control any other functions of the device, such as heating or cooling of the samples or dispensing of reagents into the sample wells 2. The control unit 17 also controls the barcode reader 19 and receives data from the barcode reader 19. The device comprises input means 18. The input means 18 function as part of the user interface of the device. Via the input means 18, a user can operate the device and for example select a specific process (assay) for processing the samples. In the embodiment of FIGS. 1 and 2, the main display 16 is a touch display which also functions as input means 18. However, the device could also comprise a keyboard and/or buttons functioning as input means. Also the auxiliary display 13 could be a touch display that functions as input means. This would enable inputting an acknowledgement of the action performed by the user, for example the user touching a text or symbol corresponding to “Yes”. Similarly, the step could be cancelled by touching a text or symbol corresponding to “Cancel”. The control unit 17 communicates both with the main display 16 and the auxiliary display 13. The device can be configured to show certain information on the main display 15 and certain other information on the auxiliary display 13. The device could also show the same information on both displays. Information shown on the auxiliary display 13 and the main display 16 can relate to each other. For instance, certain information can be shown on the auxiliary display 13 and details or further information relating to said information can be shown on the main display 16. The further information can be, for instance, additional text or a link to a file. The device can be configured to be fully operable even without the auxiliary display 13. The device can be connected to an external computer.

According to one example, the device is configured to indicate on the auxiliary display 13 that the device is ready for loading of a new sample vessel, or for removing a sample vessel from the device. This can be indicated for example by showing certain color on the display 13. Based on the instructions, the user removes a sample vessel from the device and/or loads a new sample vessel into the device. After receiving a new sample vessel, the device reads a code located in the sample vessel. Based on the read code, the device determines whether the sample vessel is suitable for the selected process. If the result is positive that is indicated on the display.

FIG. 7 shows as a flowchart a method of operating a device according to the invention. In a first step 101a of the method, it is indicated on the auxiliary display 13 that the device is ready for a specific user action. The required user action can be, for instance, loading a certain kind of sample plate into the device. The required action can be indicated, for instance, as a color code, text, image of a sample plate or any other suitable way. In a second step 102a of the method, the user action is waited for. The device can be configured to show on the display 13 the required action as long as the action has not been completed. In a third step 103a of the method, it is determined whether the completed user action is correct. For instance, if the required user action was loading a sample plate into the device, a bar code or a QR code in the sample plate can be read to determine whether the sample plate is suitable for a selected assay. In case the accomplished user action was not correct, it is indicated on the display 13 in the following step 104a. Also in case the accomplished user action was correct, it can be indicated on the display 104b. The result can be indicated, for instance, as a color code, text or image. After indicating that the user action was correct, the device can proceed to performing a succeeding action 105. Alternatively, after determining that the user action was correct, the device can proceed directly to a following step of the process. Optionally, before proceeding to the succeeding action or simultaneously with that, the device can indicate on the auxiliary display 13 that it will perform the succeeding action. Instead of proceeding to the succeeding action, in case a further user action is required, the device can indicate on the auxiliary display 13 that a second user action is required. A similar process as in FIG. 7 then follows. In case the first user action was not correct, the device can instruct on the auxiliary display 13 to correct the mistake. For instance, the device can instruct the user on which type of sample plate should be loaded into the device. The device thus operates in interaction with the user.

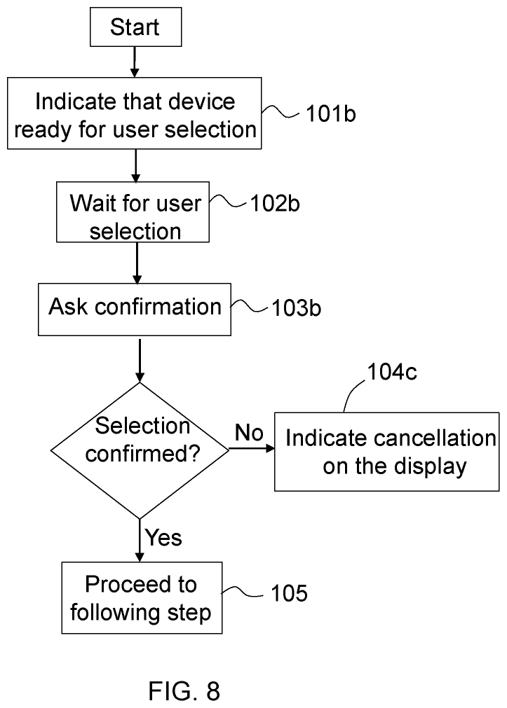

FIG. 8 shows a method according to another embodiment of the invention. In a first step of the method, it is indicated on the display 13 that the device is ready for a selection by a user 101b. In a second step of the method, the device waits for the selection 102b. The device can be configured to allow the selection using the auxiliary display 13 as input means. Alternatively, the selection can be made via other input means. After the user has made a selection, the device asks for confirmation of the selection 103b. The user can then either confirm the selection or cancel the selection. The options can be indicated on the auxiliary display 13 for instance as texts “Confirm” and “Cancel”. The user can thus use the display 13 as input means to either confirm or cancel the selection. In case the user cancels the selection, it is indicated on the auxiliary display 13 104c. In case the selection is confirmed, the device proceeds to a following step 105. Optionally, before proceeding to the following step, the confirmed selection can be indicated on the display 13. The user selection can be made between two or more predetermined options. Alternatively, the user selection can be another kind of input, e.g. input of a numerical value. By requesting a confirmation from the user, the risk of human errors is reduced.

The device can be used for many different kinds of assays and for different liquid volume ranges. Different sample vessels and probes can be used in the device. The variety of different available options means that a user can make mistakes in various phases during the use of the device. The auxiliary display enables presenting information that guides the user in a reliable way and thus lowers the risk for making mistakes. This is important in particular in IVD (in vitro diagnostics) where all process should be closely monitored for quality purposes. Thus a further acknowledgement or cancel step can improve the quality of the device, its use and the method of using the device.

It will be appreciated by a person skilled in the art that the invention is not limited to the embodiments described above, but may vary within the scope of the appended claims.

1. A device for handling samples that are located in sample wells of a sample vessel and contain magnetically responsive particles, the device comprising:
a sample handling area where the samples can be processed, and a plurality of probes that are insertable into the sample wells for removing magnetically responsive particles from the sample wells or for inserting magnetically responsive particles into the sample wells,
wherein the device comprises a display which is located underneath the sample handling area.

2. A device according to claim 1, wherein the device is configured to show on the display information instructing a user of the device.

3. A device according to claim 1, wherein the device is configured to indicate on the display when a sample vessel can be loaded into the device.

4. A device according to claim 1, wherein the device is configured to indicate on the display when a sample vessel can be removed from the device.

5. A device according to claim 1, wherein the device is configured to indicate on the display that the sample vessel is/is not correct for a selected sample handling process.

6. A device according to a claim 1, wherein the device is configured to instruct on the display how to load a sample vessel into the device.

7. A device according to claim 1, wherein the device is configured to identify on the display a sample vessel or sample wells requiring a specific action from a user of the device.

8. A device according to claim 1, wherein the device comprises a barcode or a QR-code reader or an RFID tag reader for reading information from a code or tag located in a sample vessel, and the device is configured to show on the display information based on the read code or tag.

9. A device according to claim 1, wherein the sample handling area comprises at least two predetermined sample handling locations, and the display is located underneath one of the predetermined sample handling locations.

10. A device according to claim 9, wherein the device comprises a rotatable platform for moving a sample vessel between the sample handling locations.

11. A device according to claim 9, wherein the display is located underneath a sample handling location which is configured to allow loading of a sample vessel into the device and/or removing a sample vessel from the device.

12. A device according to claim 11, wherein the display is configured to be visible to a user of the device while the sample vessel is being loaded into the device and/or removed from the device.

13. A method of operating a device according to claim 1, the method comprising the steps of:
indicating on the display that the device is ready for a user action or for a selection or input by a user,
waiting for the user action, selection or input,
determining whether the correct action has been accomplished or asking for confirmation of the selection or input, and
in case of a correct action or confirmed selection or input, proceeding to a following step of operation.

14. A method according to claim 13, wherein a wrong action or a cancelled selection or input is indicated on the display.
